(19) United States
(12) Patent Application Publication
(10) Pub. No.: US 2022/0395157 A1
(43) Pub. Date: Dec. 15, 2022

(54) WHEEL AND WHEEL-GUIDED DOMESTIC APPLIANCE

(71) Applicant: Carl Freudenberg KG, Weinheim (DE)

(72) Inventors: Willem Lijmbach, Schriesheim (DE); Christian Henn, Viernheim (DE); Christian Stenglein, Frankfurt am Main (DE)

(21) Appl. No.: 17/774,866

(22) PCT Filed: Oct. 16, 2020
(86) PCT No.: PCT/EP2020/079207

§ 371 Date: May 6, 2022

(30) Foreign Application Priority Data
Nov. 7, 2019 (DE) 10 2019 130 092.4

(51) Int. Cl. A47L 11/40; B60C 7/10; B60C 11/03

(52) U.S. Cl. CPC A47L 11/4072; B60C 7/105; B60C 11/0311; B60C 2200/00; A47L 2201/00

(57) ABSTRACT

A wheel includes: a hub; and a running wheel body, which includes a tread on an outer periphery thereof. The tread includes segments. The segments are essentially planar. First segments of the segments are inclined toward one end face of the running wheel body and second segments of the segments are inclined toward an other end face of the running wheel body.

### CROSS-REFERENCE TO PRIOR APPLICATIONS

This application is a U.S. National Phase application under 35 U.S.C. § 371 of International Application No. PCT/EP2020/079207, filed on Oct. 16, 2020, and claims benefit to German Patent Application No. DE 10 2019 130 092.4, filed on Nov. 7, 2019. The International Application was published in German on May 14, 2021 as WO 2021/089301 under PCT Article 21(2).

### FIELD

The invention relates to a wheel, comprising a hub and a running wheel body, which has a tread on its outer periphery.

### BACKGROUND

With autonomously driving, wheel-guided domestic appliances, such as cleaning robots, there is a problem in that they only have limited climbing ability. If a cleaning robot drives up to a threshold at a perpendicular or acute angle, the cleaning robot is often unable to overcome it, even when the threshold is not particularly high. Depending on the design of the domestic appliance, it is quite possible that even comparatively low thresholds, such as the bump formed by the edges of rugs, cannot be overcome. In this case, it is thus possible that surfaces lying beyond the threshold will not be reached and thus, for example, not cleaned by the domestic appliance.

### SUMMARY

In an embodiment, the present invention provides a wheel, comprising: a hub; and a running wheel body, which includes a tread on an outer periphery thereof, wherein the tread comprises segments, wherein the segments are essentially planar, and wherein first segments of the segments are inclined toward one end face of the running wheel body and second segments of the segments are inclined toward an other end face of the running wheel body.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 schematically shows a wheel; and

FIG. 2 schematically shows a cleaning robot.

### DETAILED DESCRIPTION

In an embodiment, the present invention provides a wheel, which has improved climbing ability.

The wheel according to the present invention comprises a hub and a running wheel body, which has a tread on its outer periphery, wherein the tread is formed of segments, wherein the segments are formed to be substantially planar, wherein first segments are inclined toward one end face of the running wheel body and second segments are inclined toward the other end face of the running wheel body.

A wheel formed in this way contacts the floor along a contact zone meandering in zig-zag fashion between the one end face and the other end face of the running wheel. If the wheel reaches an obstacle, such as a threshold, an angle of incidence results due to the meandering contact zone which is always smaller than 90°. This shortens the lever arm in the contact area between the obstacle and the center of gravity of the wheel. The lever arm together with the weight supported by the wheel determines the torque necessary to overcome the obstacle. Since the lever arm is shortened due to the angle of incidence, the required torque is correspondingly reduced. This enables overcoming of an obstacle also with a relatively weak torque. This is advantageous, in particular, in the context of autonomously driving domestic appliances which only have limited driving power and small wheel diameters.

Each of the first segments and the second segments preferably define a triangle. This geometry enables the greatest possible range of inclinations which the segments can achieve in relation to the axial direction of the tread.

Herein, the first segments preferably linearly abut the second segments. In this case, the tread is exclusively formed by segments having postures angled with respect to each other. Herein, first segments and second segments preferably alternate as viewed along the circumference of the tread. In this embodiment, first segments and second segments are disposed over the circumference of the tread in an alternating fashion.

Herein, the segments are preferably formed such that the first segments and the second segments are adjacent to each other along their small sides. The contact areas in the region of the small sides thus form the contact zone via which the wheel comes into contact with the floor. As seen in a plan view, the contact zone is formed as meandering in zig-zag fashion and extends along the abutting small sides from one end face of the wheel to the other end face of the wheel and back again.

The abutting edges of the segments, which form the contact zone, are preferably formed such that, as viewed over the circumference, they result in a circular envelope. In this case, the abutting edges, or small sides, of the segments are convexly shaped radially outwards in such a fashion that a circular contact zone results as viewed from the side of the wheel. This enables uniform rolling of the wheel with the same, improved climbing performance.

The segments can be provided with a profiling. The profiling can consist, for example, of grooves extending in the axial direction. The profiling improves the rolling behavior on smooth underlying surfaces.

The running wheel body can consist of an elastomeric material. In this context, it is conceivable, in particular, for the material of the running wheel body to be foamed. A running wheel body formed in such a manner has smooth running behavior and good climbing ability, and can be cost-effectively manufactured.

The running wheel body and/or the hub can be formed such that a cavity is enclosed between the running wheel body and the hub. The cavity is preferably formed to be annular and is situated between the running wheel body and the hub. The cavity results in a resilient behavior of the wheel, which is advantageous, in particular, with uneven surfaces and enables vibration-free movement.

A wheel-guided domestic appliance according to the invention comprises at least one wheel according to the invention. Domestic appliances are often equipped with small wheels only having limited climbing ability. The wheel according to the present invention improves climbing ability so that the domestic appliance has improved handling and improved usage properties.

According to an advantageous embodiment, the domestic appliance is formed to move autonomously. In this case, the domestic appliance is equipped with a motive drive, preferably an electric motor with a storage battery, and with one or more wheels according to the invention. Particularly preferably, the driven wheels are formed in the manner according to the present invention.

The domestic appliance can be formed as a cleaning robot. An advantageous cleaning robot comprises two wheels, formed according to the present invention, driven by electric motors. Furthermore, the cleaning robot is provided with a third wheel, which is formed as a roller-like wheel. The third wheel can be rotatably supported in the base frame of the cleaning robot so that the third wheel enables a change of direction to be performed by the cleaning robot. The cleaning robot autonomously moves about the room to be cleaned and performs cleaning operations. The design of the wheels according to the invention makes it possible for the robot to overcome obstacles such as the edges of rugs and the like. This increases the operating range available to the cleaning robot.

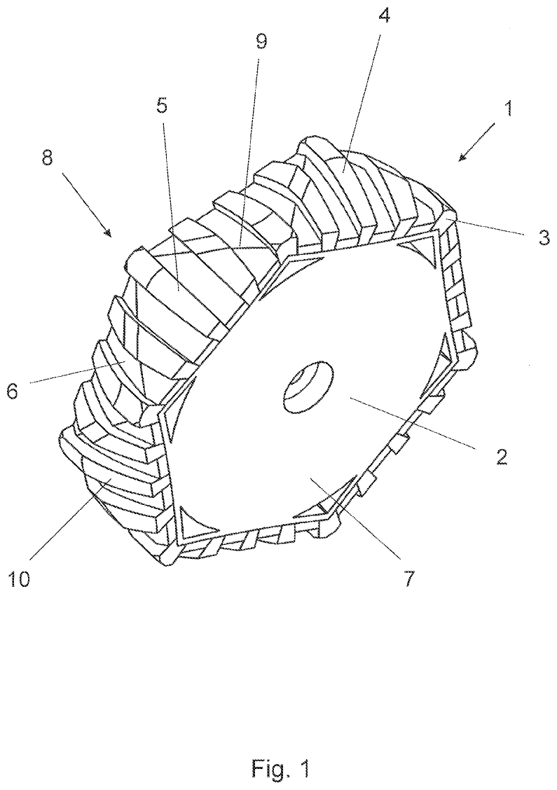

FIG. 1 shows a wheel 1, comprising a hub 2 and a running wheel body 3, wherein the running wheel body 3 has a tread 4 on its outer periphery. The hub 2 is made of plastic material. The running wheel body 3 consists of a foamed elastomer. An annular cavity is formed between the hub 2 and the running wheel body 3.

The tread 4 is made up of segments 5, 6, wherein the segments 5, 6 are essentially formed to be planar. First segments 5 are inclined toward one end face 7 of the running wheel body 3 and second segments 6 are inclined toward the other end face 8 of the running wheel body 3. Each of the first segments 5 and the second segments 6 define a triangle, wherein the first segments 5 and the second segments 6 are linearly adjacent to each other along their small sides. In the linear contact area of the small sides, an abutting edge 9 is formed, which forms a contact zone to the underlying surface, on which the wheel 1 is moving.

The abutting edges 9 of the segments 5, 6, i. e., the adjacent small sides, are formed such that, as viewed from the side, a circular envelope results over the circumference. To achieve this, the abutting edges 9 are convexly shaped radially outwards. Herein, the convex dome-shape is highest in the central area of the small sides and is reduced toward the end faces.

The segments 5, 6 are provided with a profiling 10, which, in the present embodiment, is formed of grooves extending in the axial direction.

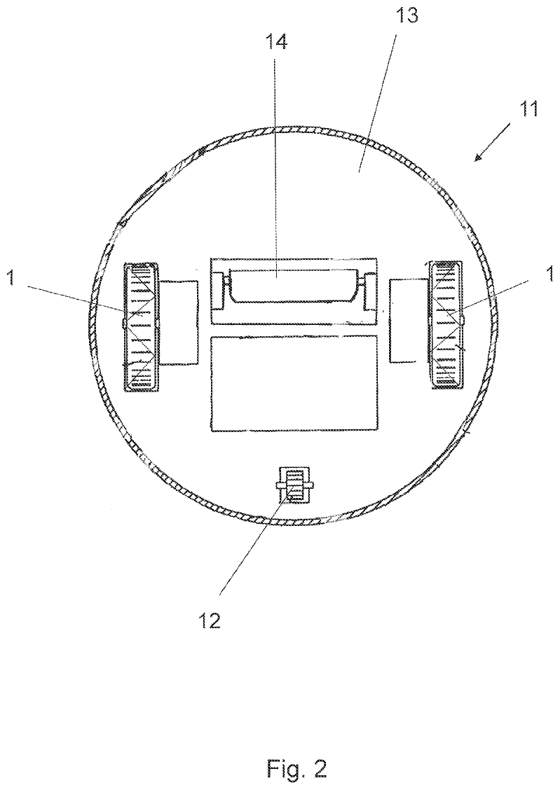

FIG. 2 shows a wheel-guided domestic appliance which, in the present exemplary embodiment, is formed as an automatically driving domestic appliance in the form of a cleaning robot 11.

The cleaning robot 11 comprises a base frame 13 having a bottom side, from which two wheels 1 as described with reference to FIG. 1 protrude. The wheels 1 have an electromotive drive. To achieve this, the cleaning robot 11 is provided with an electric motor, a storage battery and a belt drive, wherein the belt drive is effectively connected to the wheels 1. Furthermore, the bottom side of the base frame 13 has a cleaning device 14, in the present case, a brush assembly associated with it.

The cleaning robot 11 is also equipped with a third wheel 12, which has a roller-like configuration. The third wheel 12 is pivotably supported in the base frame 13, so that the cleaning robot 11 can autonomously perform changes of direction.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A,

1. A wheel, comprising:
a hub; and
a running wheel body, which includes a tread on an outer periphery thereof,
wherein the tread comprises segments,
wherein the segments are essentially planar, and
wherein first segments of the segments are inclined toward one end face of the running wheel body and second segments of the segments are inclined toward an other end face of the running wheel body.

2. The wheel of claim 1, wherein each of the first segments and the second segments define a triangle.

3. The wheel of claim 1, wherein the first segments and the second segments are linearly adjacent to each other.

4. The wheel of claim 2, wherein the first segments and the second segments are adjacent to each other along small sides thereof.

5. The wheel of claim 1, wherein abutting edges of the segments are formed so as to provide a circular envelope over a circumference of the tread.

6. The wheel of claim 1, wherein the segments are provided with a profiling.

7. The wheel of claim 1, wherein the running wheel body comprises an elastomeric material.

8. The wheel of claim 1, wherein the running wheel body together with the hub encloses a cavity.

9. A wheel-guided domestic appliance, comprising:
at least one wheel of claim 1.

10. The domestic appliance of claim 9, wherein the domestic appliance is configured to move autonomously.

11. The domestic appliance of claim 9, wherein the domestic appliance comprises a cleaning robot.
